(19) United States
(12) Patent Application Publication
(10) Pub. No.: US 2025/0183794 A1
(43) Pub. Date: Jun. 5, 2025

(54) FLYBACK CONVERTER WITH ELECTROMAGNETIC INTERFERENCE SUPPRESSION FUNCTION

(71) Applicant: Xiamen PVTECH Co., Ltd., Xiamen (CN)

(72) Inventors: FUXING LU, Xiamen (CN); ZHIRONG LIN, Xiamen (CN)

(73) Assignee: Xiamen PVTECH Co., Ltd., Xiamen (CN)

(21) Appl. No.: 18/963,410

(22) Filed: Nov. 27, 2024

(30) Foreign Application Priority Data
Dec. 1, 2023 (CN) 202311649070.5

(51) Int. Cl. H02M 1/44; H02M 3/335

(52) U.S. Cl. CPC H02M 1/44; H02M 3/33569

(57) ABSTRACT

A flyback converter with electromagnetic interference suppression function includes an input end, an output end, a rectifying element, and a transformer. The output end includes a first output terminal and a second output terminal. The transformer includes a primary winding, a first secondary winding, and a second secondary winding. The primary winding is connected to the input end. The upper terminal of the first secondary winding is connected to the first output terminal, and the lower terminal of the first secondary winding is connected to the first end of the rectifying element. The upper terminal of the second secondary winding is connected to the second end of the rectifying element, and the lower terminal of the second secondary winding is connected to the second output terminal.

### BACKGROUND OF THE INVENTION

### 1. Field of the Invention

The present invention relates to a flyback converter, in particular to a flyback converter with electromagnetic interference suppression function.

### 2. Description of the Prior Art

Currently available low-power (less than 200 watts) isolated lighting device drivers mostly use flyback converters. These isolated lighting device drivers utilizing flyback converters are well-established and reliable, so these drivers are comprehensively used in various applications.

However, during the operation of flyback converters, significant electromagnetic interference (EMI) is generated, necessitating complex filter circuits to reduce this interference. These filter circuits are generally costly, which consequently increases the overall cost of the lighting device. Therefore, improving the circuit design of the currently available flyback converters to effectively suppress EMI has become an urgent issue.

China Patent Publication No. CN104619076A and China Patent Publication No. CN105871194A also disclose improved converter circuit designs, but these circuit designs still fail to effectively address the above problems.

### SUMMARY OF THE INVENTION

One embodiment of the present invention provides a flyback converter with electromagnetic interference suppression function, which includes an input end, an output end, a rectifying element, and a transformer. The output end includes a first output terminal and a second output terminal. The transformer includes a primary winding, a first secondary winding, and a second secondary winding. The primary winding is connected to the input end. The upper terminal of the first secondary winding is connected to the first output terminal, and the lower terminal of the first secondary winding is connected to the first end of the rectifying element. The upper terminal of the second secondary winding is connected to the second end of the rectifying element, and the lower terminal of the second secondary winding is connected to the second output terminal.

In one embodiment, the rectifying element is a diode. The lower terminal of the first secondary winding is connected to the cathode of the diode, and the upper terminal of the second secondary winding is connected to the anode of the diode.

In one embodiment, the waveform of the signal passing through the lower terminal of the first secondary winding is opposite to the waveform of the signal passing through the upper terminal of the second secondary winding.

In one embodiment, the number of turns of the first secondary winding is equal to the number of turns of the second secondary winding.

In one embodiment, the phase of the primary winding is opposite to the phase of the first secondary winding and the phase of the second secondary winding.

In one embodiment, the input terminal includes a first input terminal and a second input terminal. The first input terminal is connected to the upper terminal of the primary winding, and the second input terminal is connected to the lower terminal of the primary winding.

In one embodiment, the flyback converter further includes a first capacitor. One end of the first capacitor is connected to the first input terminal, and the other end of the first capacitor is connected to the second input terminal.

In one embodiment, the flyback converter further includes a resistor and a switch element. The second input terminal is connected to the lower terminal of the primary winding via the resistor and the switch element.

In one embodiment, the switch element is a metal-oxide-semiconductor field-effect transistor or a bipolar junction transistor.

In one embodiment, the flyback converter further includes a second capacitor. One end of the second capacitor is connected to the first output terminal, and the other end of the second capacitor is connected to the second output terminal.

The flyback converter with electromagnetic interference suppression function in accordance with the embodiments of the present invention may have the following advantages:

(1) In one embodiment of the present invention, the flyback converter includes an input end, an output end, a rectifying element, and a transformer. The output end includes a first output terminal and a second output terminal. The transformer includes a primary winding, a first secondary winding, and a second secondary winding. The primary winding is connected to the input end. The upper terminal of the first secondary winding is connected to the first output terminal, and the lower terminal of the first secondary winding is connected to the first end of the rectifying element. The upper terminal of the second secondary winding is connected to the second end of the rectifying element, and the lower terminal of the second secondary winding is connected to the second output terminal. This structural design of the primary winding, first secondary winding, second secondary winding, and rectifying element achieves an effective noise suppression mechanism that creates two noise signal propagation paths in opposite directions. In this way, noise signals can cancel each other out, so as to effectively suppress electromagnetic interference. Therefore, the performance of the flyback converter can be significantly improved to meet actual requirements.

(2) In one embodiment of the present invention, the flyback converter has a unique and effective noise suppression mechanism, which can generate two noise signal propagation paths in opposite directions. This noise suppression mechanism allows noise signals to cancel each other out effectively, suppressing electromagnetic interference without requiring complex filter circuits. As a result, the cost of the flyback converter can be significantly reduced, so the flyback converter can be comprehensive in application and capable of meeting the demands of various applications.

(3) In one embodiment of the present invention, the flyback converter has a unique and effective noise suppression mechanism for efficiently suppressing electromagnetic interference. Therefore, the performance of the flyback converter can be effectively enhanced, and the performance and reliability of the lighting device can also be significantly improved. Consequently, the flyback converter aligns well with future development trends.

(4) In one embodiment of the present invention, the circuit design of the flyback converter not only achieves an effective noise suppression mechanism but also can be applied to various circuits without modifying the circuit design of other functional modules in the lighting device. Therefore, the flyback converter offers high compatibility and can be more flexible in use.

(5) In one embodiment of the present invention, the flyback converter can achieve the desired effects without substantially increasing the cost thereof, while also enhancing the performance and reliability of the lighting device. Therefore, the flyback converter offers high practicality in order to meet the diverse needs of different users.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is the circuit diagram of the flyback converter with electromagnetic interference suppression function in accordance with the first embodiment of the present invention.

FIG. 2 is the circuit diagram of the flyback converter with electromagnetic interference suppression function in accordance with the second embodiment of the present invention.

FIG. 3 is the schematic view of the operating state of the flyback converter with electromagnetic interference suppression function in accordance with the second embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

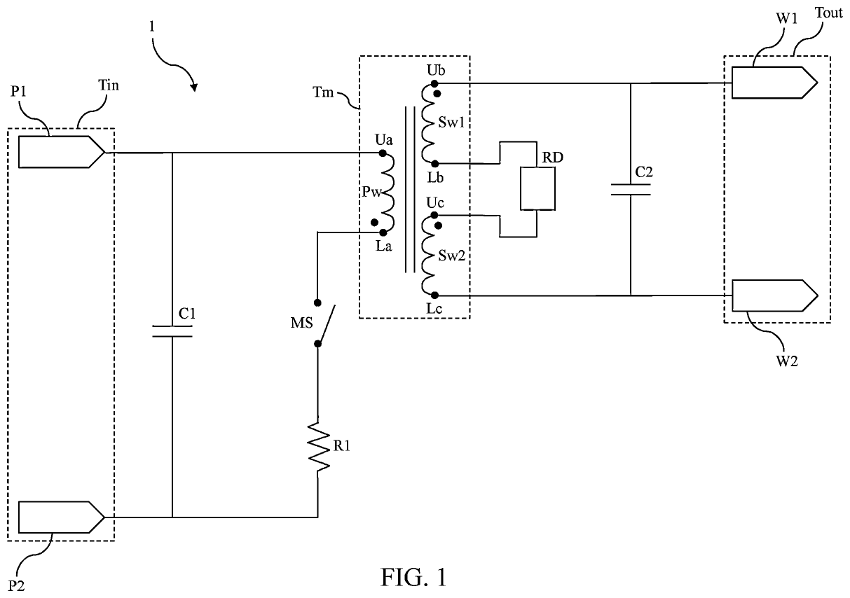

Please refer to FIG. 1, which is the circuit diagram of the flyback converter electromagnetic with interference (EMI) suppression function in accordance with the first embodiment of the present invention. As shown in FIG. 1, the flyback converter 1 includes an input terminal Tin, an output terminal Tout, a rectifying element RD, a transformer Tm, a first capacitor C1, a second capacitor C2, a resistor R1, and a switch element MS.

The input terminal Tin includes a first input terminal P1 and a second input terminal P2. In this embodiment, the first input terminal P1 serves as the positive input, while the second input terminal P2 serves as the negative input. In another embodiment, the first input terminal P1 could be the negative input, and the second input terminal P2 could be the positive input.

The output terminal Tout includes a first output terminal W1 and a second output terminal W2. In this embodiment, the first output terminal W1 serves as the positive output, while the second output terminal W2 serves as the negative output. In another embodiment, the first output terminal W1 could be the negative output, and the second output terminal W2 could be the positive output.

The transformer Tm includes a primary winding Pw, a first secondary winding Sw1, and a second secondary winding Sw2. The phase of the primary winding Pw is opposite to the phases of both the first secondary winding Sw1 and the second secondary winding Sw2. The number of turns of the first secondary winding Sw1 may be equal to the number of turns of the second secondary winding Sw2. The primary winding Pw is connected to the input terminal Tin; specifically, the upper terminal Ua of the primary winding Pw is connected to the first input terminal P1, while the lower terminal La of the primary winding Pw is connected to the second input terminal P2 through the resistor R1 and the switch element MS. The upper terminal Ub of the first secondary winding Sw1 is connected to the first output terminal W1, while the lower terminal Lb of the first secondary winding Sw1 is connected to the first end of the rectifying element RD. The upper terminal Uc of the second secondary winding Sw2 is connected to the second end of the rectifying element RD, and the lower terminal Lc of the second secondary winding Sw2 is connected to the second output terminal W2. In one embodiment, the rectifying element RD is a diode. In another embodiment, the rectifying element RD may be any component with a rectifying function. In one embodiment, the switch element MS is a metal-oxide-semiconductor field-effect transistor (MOSFET). In another embodiment, the switch element MS may be a bipolar junction transistor (BJT) or another similar component.

One end of the first capacitor C1 is connected to the first input terminal P1, while the other end is connected to the second input terminal P2. One end of the second capacitor C2 is connected to the first output terminal W1, and the other end is connected to the second output terminal W2.

The above circuit design is merely exemplary and not restrictive, and this circuit design can be applied to various currently available flyback converters; the present invention is not limited by the above embodiment.

As indicated above, this embodiment of the flyback converter 1 includes the input terminal Tin, the output terminal Tout, the rectifying element RD, and the transformer Tm. The output terminal Tout includes the first output terminal W1 and the second output terminal W2. The transformer Tm includes the primary winding Pw, the first secondary winding Sw1, and the second secondary winding Sw2. The primary winding Pw is connected to the input terminal Tin. The upper terminal Ub of the first secondary winding Sw1 is connected to the first output terminal W1, while the lower terminal Lb of the first secondary winding Sw1 is connected to the first end of the rectifying element RD. The upper terminal Uc of the second secondary winding Sw2 is connected to the second end of the rectifying element RD, while the lower terminal Lc of the second secondary winding Sw2 is connected to the second output terminal W2. This structural design of the primary winding Pw, first secondary winding Sw1, second secondary winding Sw2, and rectifying element RD enables an effective noise suppression mechanism by generating two noise signal propagation paths in opposite directions. This allows noise signals to cancel each other out, thereby effectively suppressing electromagnetic interference. Consequently, the performance of the flyback converter 1 can be significantly enhanced to meet practical application requirements.

This noise suppression mechanism allows noise signals to cancel each other out effectively, reducing electromagnetic interference without the need for complex filtering circuits. As a result, the cost of the flyback converter 1 can be significantly lowered, making it more widely applicable and suitable for various applications. At the same time, the performance of the flyback converter 1 can be effectively improved, thereby enhancing the performance and reliability of lighting devices. Therefore, the flyback converter 1 aligns well with future development trends.

Furthermore, the circuit design of the flyback converter 1 not only achieves an effective noise suppression mechanism but also can be applied to various circuits without requiring modifications to other functional modules in the lighting device. This high compatibility enhances the flexibility of the flyback converter 1 in diverse applications.

The embodiment just exemplifies the present invention and is not intended to limit the scope of the present invention; any equivalent modification and variation according to the spirit of the present invention is to be also included within the scope of the following claims and their equivalents.

It is worthy to point out that during the operation of currently available flyback converters, significant electromagnetic interference (EMI) is generated, necessitating complex filter circuits to reduce this interference. These filter circuits are generally costly, which consequently increases the overall cost of the lighting device. By contrast, according to one embodiment of the present invention, the flyback converter includes an input end, an output end, a rectifying element, and a transformer. The output end includes a first output terminal and a second output terminal. The transformer includes a primary winding, a first secondary winding, and a second secondary winding. The primary winding is connected to the input end. The upper terminal of the first secondary winding is connected to the first output terminal, and the lower terminal of the first secondary winding is connected to the first end of the rectifying element. The upper terminal of the second secondary winding is connected to the second end of the rectifying element, and the lower terminal of the second secondary winding is connected to the second output terminal. This structural design of the primary winding, first secondary winding, second secondary winding, and rectifying element achieves an effective noise suppression mechanism that creates two noise signal propagation paths in opposite directions. In this way, noise signals can cancel each other out, so as to effectively suppress electromagnetic interference. Therefore, the performance of the flyback converter can be significantly improved to meet actual requirements.

Also, according to one embodiment of the present invention, the flyback converter has a unique and effective noise suppression mechanism, which can generate two noise signal propagation paths in opposite directions. This noise suppression mechanism allows noise signals to cancel each other out effectively, suppressing electromagnetic interference without requiring complex filter circuits. As a result, the cost of the flyback converter can be significantly reduced, so the flyback converter can be comprehensive in application and capable of meeting the demands of various applications.

Further, according to one embodiment of the present invention, the flyback converter has a unique and effective noise suppression mechanism for efficiently suppressing electromagnetic interference. Therefore, the performance of the flyback converter can be effectively enhanced, and the performance and reliability of the lighting device can also be significantly improved. Consequently, the flyback converter aligns well with future development trends.

Moreover, according to one embodiment of the present invention, the circuit design of the flyback converter not only achieves an effective noise suppression mechanism but also can be applied to various circuits without modifying the circuit design of other functional modules in the lighting device. Therefore, the flyback converter offers high compatibility and can be more flexible in use.

Furthermore, according to one embodiment of the present invention, the flyback converter can achieve the desired effects without substantially increasing the cost thereof, while also enhancing the performance and reliability of the lighting device. Therefore, the flyback converter offers high practicality in order to meet the diverse needs of different users. As set forth above, the flyback converter with electromagnetic interference suppression function according to the embodiments of the present invention can achieve great technical effects.

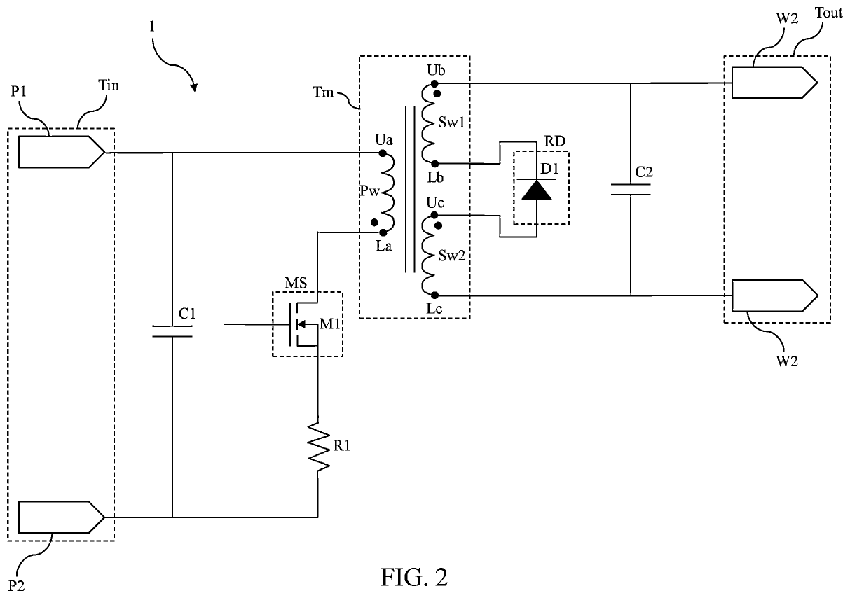

Please refer to FIG. 2, which is the circuit diagram of the flyback converter with electromagnetic interference suppression function in accordance with the second embodiment of the present invention. As shown in FIG. 2, the flyback converter 1 includes an input terminal Tin, an output terminal Tout, a rectifying element RD, a transformer Tm, a first capacitor C1, a second capacitor C2, a resistor R1, and a switch element MS.

The input terminal Tin includes a first input terminal P1 and a second input terminal P2. In this embodiment, the first input terminal P1 serves as the positive input, while the second input terminal P2 serves as the negative input.

The output terminal Tout includes a first output terminal W1 and a second output terminal W2. In this embodiment, the first output terminal W1 serves as the positive output, while the second output terminal W2 serves as the negative output.

The rectifying element RD is connected to the transformer Tm. In this embodiment, the rectifying element RD is a diode D1.

The transformer Tm includes a primary winding Pw, a first secondary winding Sw1, and a second secondary winding Sw2. The phase of the primary winding Pw is opposite to the phases of both the first secondary winding Sw1 and the second secondary winding Sw2. The number of turns of the first secondary winding Sw1 can be equal to that of the second secondary winding Sw2. The primary winding Pw is connected to the input terminal Tin; specifically, the upper terminal Ua of the primary winding Pw is connected to the first input terminal P1, while the lower terminal La of the primary winding Pw is connected to the second input terminal P2 through the resistor R1 and the switch element MS. In this embodiment, the switch element MS is a transistor M1, which may be a MOSFET. The second input terminal P2 is connected to one end of the resistor R1, while the other end of resistor R1 is connected to the source of transistor M1. The drain of transistor M1 is connected to the lower terminal La of the primary winding Pw, and the gate of transistor M1 is connected to a control power supply. The upper terminal Ub of the first secondary winding Sw1 is connected to the first output terminal W1, while the lower terminal Lb of the first secondary winding Sw1 is connected to the cathode of diode D1. The upper terminal Uc of the second secondary winding Sw2 is connected to the anode of diode D1, and the lower terminal Lc of the second secondary winding Sw2 is connected to the second output terminal W2.

One end of the first capacitor C1 is connected to the first input terminal P1, and the other end of the first capacitor C1 is connected to the second input terminal P2.

One end of the second capacitor C2 is connected to the first output terminal W1, while the other end of the second capacitor C2 is connected to the second output terminal W2.

The above circuit design is merely exemplary and not restrictive, and this circuit design can be applied to various currently available flyback converters; the present invention is not limited by the above embodiment.

The embodiment just exemplifies the present invention and is not intended to limit the scope of the present invention; any equivalent modification and variation according to the spirit of the present invention is to be also included within the scope of the following claims and their equivalents.

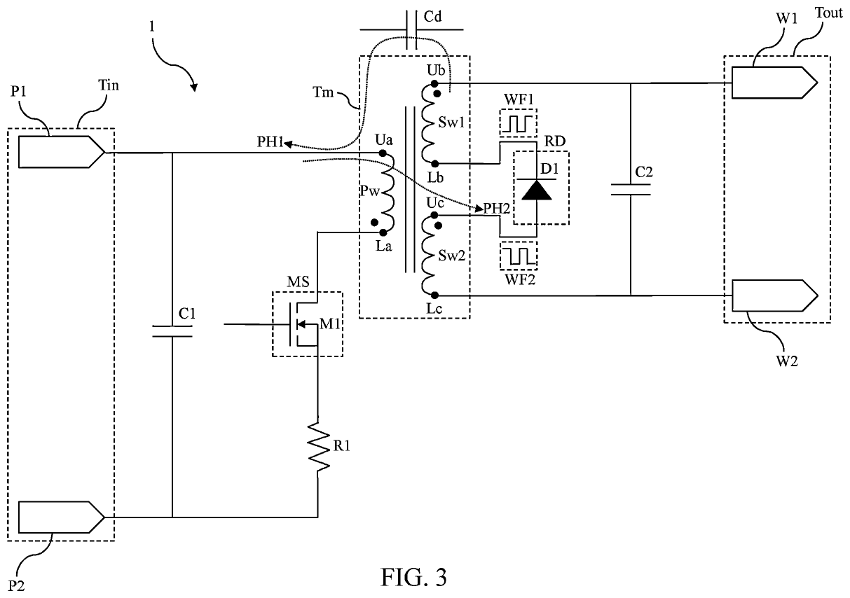

Please refer to FIG. 3, which is the schematic view of the operating state of the flyback converter with electromagnetic interference suppression function in accordance with the second embodiment of the present invention. As shown in FIG. 3, the differential mode noise sources are the lower terminal Lb of the first secondary winding Sw1 and the upper terminal Uc of the second secondary winding Sw2. Since the waveform WF1 of the signal passing through the lower terminal Lb of the first secondary winding Sw1 is opposite to the waveform WF2 of the signal passing through the upper terminal Uc of the second secondary winding Sw2, the potential pf the noise signal at the lower terminal Lb of the first secondary winding Sw1 will also be opposite to the potential of the noise signal at the upper terminal Uc of the second secondary winding Sw2.

When the noise signal at the lower terminal Lb of the first secondary winding Sw1 changes from low to high, this change will be coupled through distributed capacitance Cd from the upper terminal Ub of the first secondary winding Sw1 to the upper terminal Ua of the primary winding Pw. Therefore, the noise signal propagation path of the noise signal at the lower terminal Lb of the first secondary winding Sw1 is designated as PH1. Similarly, the noise signal at the upper terminal Ua of the primary winding Pw will also couple to the upper terminal Uc of the second secondary winding Sw2. Thus, the noise signal propagation path of the noise signal at the upper terminal Ua of the primary winding Pw is designated as PH2.

With this circuit design, the opposite waveforms of the signal passing through the lower terminal Lb of the first secondary winding Sw1 and the signal passing through the upper terminal Uc of the second secondary winding Sw2 create two opposing noise signal propagation paths (PH1 and PH2). In this way, the noise signals can cancel each other out, effectively suppressing electromagnetic interference. Consequently, the performance of the flyback converter 1 can be greatly improved to meet practical application requirements.

This noise suppression mechanism can cancel noise signals effectively without the need for complex filtering circuits, thus effectively suppressing electromagnetic interference. Therefore, the cost of the flyback converter 1 can be significantly reduced, such that the flyback converter 1 can be more comprehensive in application and adaptable to various application needs. Additionally, the performance of the flyback converter 1 can be effectively enhanced, thereby also greatly improving the performance and reliability of lighting devices. This makes the flyback converter 1 better suited to meet future development trends.

Furthermore, the circuit design of the flyback converter 1 can achieve an effective noise suppression mechanism. Besides, the flyback converter 1 can be applied to various circuits without the need to modify other functional modules in lighting devices. Therefore, the flyback converter 1 can achieve high compatibility, so the flyback converter 1 can be more flexible in use.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the present invention, the flyback converter includes an input end, an output end, a rectifying element, and a transformer. The output end includes a first output terminal and a second output terminal. The transformer includes a primary winding, a first secondary winding, and a second secondary winding. The primary winding is connected to the input end. The upper terminal of the first secondary winding is connected to the first output terminal, and the lower terminal of the first secondary winding is connected to the first end of the rectifying element. The upper terminal of the second secondary winding is connected to the second end of the rectifying element, and the lower terminal of the second secondary winding is connected to the second output terminal. This structural design of the primary winding, first secondary winding, second secondary winding, and rectifying element achieves an effective noise suppression mechanism that creates two noise signal propagation paths in opposite directions. In this way, noise signals can cancel each other out, so as to effectively suppress electromagnetic interference. Therefore, the performance of the flyback converter can be significantly improved to meet actual requirements.

Also, according to one embodiment of the present invention, the flyback converter has a unique and effective noise suppression mechanism, which can generate two noise signal propagation paths in opposite directions. This noise suppression mechanism allows noise signals to cancel each other out effectively, suppressing electromagnetic interference without requiring complex filter circuits. As a result, the cost of the flyback converter can be significantly reduced, so the flyback converter can be comprehensive in application and capable of meeting the demands of various applications.

Further, according to one embodiment of the present invention, the flyback converter has a unique and effective noise suppression mechanism for efficiently suppressing electromagnetic interference. Therefore, the performance of the flyback converter can be effectively enhanced, and the performance and reliability of the lighting device can also be significantly improved. Consequently, the flyback converter aligns well with future development trends.

Moreover, according to one embodiment of the present invention, the circuit design of the flyback converter not only achieves an effective noise suppression mechanism but also can be applied to various circuits without modifying the circuit design of other functional modules in the lighting device. Therefore, the flyback converter offers high compatibility and can be more flexible in use.

Furthermore, according to one embodiment of the present invention, the flyback converter can achieve the desired effects without substantially increasing the cost thereof, while also enhancing the performance and reliability of the lighting device. Therefore, the flyback converter offers high practicality in order to meet the diverse needs of different users.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flyback converter with electromagnetic interference suppression function, comprising:
an input end;
an output end comprising a first output terminal and a second output terminal;
a rectifying element; and
a transformer comprising a primary winding, a first secondary winding, and a second secondary winding, wherein the primary winding is connected to the input end, an upper terminal of the first secondary winding is connected to the first output terminal, a lower terminal of the first secondary winding is connected to a first end of the rectifying element, an upper terminal of the second secondary winding is connected to a second end of the rectifying element, and a lower terminal of the second secondary winding is connected to the second output terminal.

2. The flyback converter with electromagnetic interference suppression function as claimed in claim 1, wherein the rectifying element is a diode, the lower terminal of the first secondary winding is connected to a cathode of the diode, and the upper terminal of the second secondary winding is connected to an anode of the diode.

3. The flyback converter with electromagnetic interference suppression function as claimed in claim 1, wherein a waveform of a signal passing through the lower terminal of the first secondary winding is opposite to a waveform of a signal passing through the upper terminal of the second secondary winding.

4. The flyback converter with electromagnetic interference suppression function as claimed in claim 1, wherein a number of turns of the first secondary winding is equal to a number of turns of the second secondary winding.

5. The flyback converter with electromagnetic interference suppression function as claimed in claim 1, wherein a phase of the primary winding is opposite to a phase of the first secondary winding and a phase of the second secondary winding.

6. The flyback converter with electromagnetic interference suppression function as claimed in claim 1, wherein the input terminal comprises a first input terminal and a second input terminal, the first input terminal is connected to an upper terminal of the primary winding, and the second input terminal is connected to a lower terminal of the primary winding.

7. The flyback converter with electromagnetic interference suppression function as claimed in claim 6, further comprising a first capacitor, wherein one end of the first capacitor is connected to the first input terminal, and another end of the first capacitor is connected to the second input terminal.

8. The flyback converter with electromagnetic interference suppression function as claimed in claim 6, further comprising a resistor and a switch element, wherein the second input terminal is connected to the lower terminal of the primary winding via the resistor and the switch element.

9. The flyback with electromagnetic interference suppression function as claimed in claim 8, wherein the switch element is a metal-oxide-semiconductor field-effect transistor or a bipolar junction transistor.

10. The flyback converter with electromagnetic interference suppression function as claimed in claim 1, further comprising a second capacitor, wherein one end of the second capacitor is connected to the first output terminal, and another end of the second capacitor is connected to the second output terminal.
